(19) United States
(12) Patent Application Publication
(10) Pub. No.: US 2023/0193082 A1
(43) Pub. Date: Jun. 22, 2023

(54) FILM STACK WITH OVERLAMINATE FILM LAYER AND REMOVABLE SKIN LAYER

(71) Applicant: 3M INNOVATIVE PROPERTIES COMPANY, St. Paul, MN (US)

(72) Inventors: Huiwen Tai, Lake Elmo, MN (US); John A. Nielsen, Woodbury, MN (US)

(21) Appl. No.: 17/911,792

(22) PCT Filed: Mar. 16, 2021
(86) PCT No.: PCT/IB2021/052194

§ 371 Date: Sep. 15, 2022

Related U.S. Application Data
(60) Provisional application No. 62/993,534, filed on Mar. 23, 2020.

(51) Int. Cl. C09J 7/20

(52) U.S. Cl. CPC C09J 7/203; C09J 2203/338; C09J 2301/308; C09J 2423/105

(57) ABSTRACT

Film stacks are described. In particular, film stacks including a base overlaminate film layer and a removeable skin layer disposed on the base overlaminate film layer are described. Because the removable skin layer develops haze before the point of irreversibly damaging the base overlaminate layer, the film stack can prevent unintentional overstretching when the film stack is stretched together.

### BACKGROUND

Film stacks including overlaminate film layers are used in graphics films applications to protect and add durability to the printed or otherwise imaged graphics film, especially the ink. A removable skin layer is an outer layer that can be stripped by a user at or after the time of application.

### SUMMARY

In one aspect, the present description relates to a film stack. The film stack includes a base overlaminate film layer formed from a first material and having first and second major surfaces, a removable skin layer formed from a second material disposed on the first major surface of the base overlaminate film, and an adhesive layer disposed on the second major surface of the base overlaminate film. The base overlaminate film is transparent. The removable skin layer is more rigid than the base overlaminate film layer. The film stack is stretchable to 30% elongation without causing irreversible damage to the base overlaminate layer.

In another aspect, the present description relates to a film stack. The film stack includes a base overlaminate film layer and a removable skin layer disposed on a major surface of the base overlaminate film. When the film stack is stretched, the removable skin layer provides a visible indication before reaching the causing irreversible damage to the overlaminate film layer.

In yet another aspect, the present description relates to a method of preventing overstretching while stretching a film stack. The method includes providing a film stack including a base overlaminate film layer and a removable skin layer disposed on the base overlaminate film layer, where the removable skin layer—when the film in stretched—becomes hazy before causing irreversible damage to the base overlaminate film layer; and stretching the film stack less than or up to the point when the removable skin layer becomes hazy.

### BRIEF DESCRIPTION OF THE DRAWINGS

FIG. 1 is a schematic side elevation cross section of a film stack including a base overlaminate film layer and a removable skin layer.

FIG. 2 is a schematic side elevation cross section of another film stack including two base overlaminate film layers and two removable skin layers.

FIG. 3A-3C are schematic top plan views of an unstretched film stack, a film stack stretched so that the removable skin layer develops haze, and a film stack with the hazy removable skin layer delaminated from the film stack, revealing the base overlaminate film layer underneath.

FIG. 4 is a graph showing load force versus elongation for Example 3 (and its components) and Comparative Example 5.

### DETAILED DESCRIPTION

Overlaminates are used in graphics films to protect or enhance the durability of printed base graphics films. Overlaminates may provide physical protection, such as against abrasion or ambient conditions. Overlaminates may help extend the usable or optimal lifetime of printed graphics film products. Conventionally, overlaminates are laminated to a printed base graphics film at or after the time of printing.

The external surface of the overlaminate film can dictate the overall appearance of the film stack to an observer. For example, a glossy external surface (with little surface structure) provides a high percentage of specular versus diffuse reflection, and typically low haze and high clarity. Other desired external surface structures may be desired; for example, certain overlaminates may have a matte structure or other textured surface. For this reason, it is important to preserve and protect the surface characteristics of the overlaminate film. Surface scratches and other defects may affect the final appearance of the film stack and may be objectionable to a customer or an observer. Therefore, a protective skin layer is typically provided on the surface of the film, to be removed after lamination or final application, which may require squeegeeing or other physical contact that may damage the exposed surface.

Additionally, overlaminates may be thin, highly conformable, and therefore difficult to handle. A removable skin layer may impart sufficient stiffness for easier handling. Conventionally, once the overlaminate is laminated to the base graphics film, or after the combined film stack is adhered to the desired surface or substrate, the removable skin layer may be removed.

Paper liners or polymeric materials are conventionally laminated to the base overlaminate film, which is formed in a different step. This typically requires an additional adhesive layer and attachment step, which can add complexity to the process of manufacturing. Or, temporary liners are provided on the front surface as protection just during the installation step. Paper liners are opaque and will not allow an installer to see the graphic during installation.

Certain removable skin layers described herein may be formed through a blown film extrusion or traditional extrusion process and may be co-formed with a base overlaminate film, eliminating the need for a separate adhesive and/or heat lamination process. Such removable skin layers may require modest peel forces to strip the layer from the base overlaminate film, while still staying securely attached through shipping, handling, and installation.

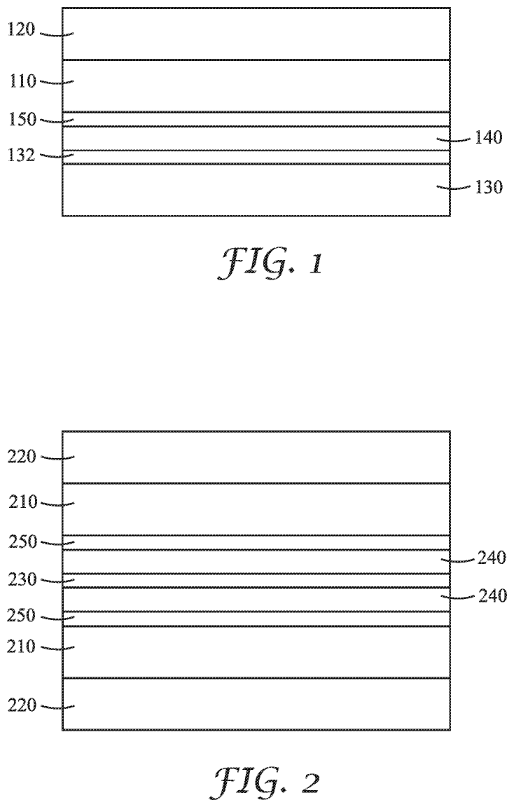

FIG. 1 is a schematic side elevation cross section of a film stack including a base overlaminate film layer and a removable skin layer. FIG. 1 includes film stack 100 including base overlaminate film layer 110, removable skin layer 120, liner 130 with optional release layer 132, pressure sensitive adhesive 140, and optional tie layer 150.

Base overlaminate film layer 110 may be any suitable material and may be formed through any suitable process. In some embodiments, the base overlaminate film layer includes or in made from polyvinyl chloride. In some embodiments, the base overlaminate film layer includes polyurethane and cellulose acetate propionate or cellulose acetate butyrate. In some embodiments, the base overlaminate film layer includes or is made from a polyester or copolyester. In some embodiments, the base overlaminate film includes or is made from ionomer resin of a copolymer of ethylene and methacrylic acid. In some embodiments, the base overlaminate film layer includes or is made from ethylene vinyl acetate (EVA). In some embodiments, the base overlaminate film layer includes or is made from polycarbonate, polypropylene, or polystyrene. In some embodiments, the base overlaminate film layer includes or contains an elastomeric component. Block copolymers including polyamides and polyamides may be suitable. The particular material or combination of materials may be selected for their physical, optical, and/or rheological properties. In some embodiments, the base overlaminate film layer may include more than one layer, the more than one layer including the same or different materials.

Base overlaminate film layer 110 may have any suitable thickness, and may be formed through an extrusion (such as melt extrusion or blown film extrusion) process. In some embodiments, base overlaminate film layer 110 has a thickness of 25-100 micrometers. Base overlaminate film layer 110 may have a smooth surface structure or may have a textured surface structure.

Removable skin layer 120 may be any suitable material and may be formed from any suitable material. In some embodiments, the removable skin layer is more rigid than the base overlaminate film layer. In some embodiments, removable skin layer 120 may be or include polypropylene. In some embodiments, removable skin layer 120 may be or include any other suitable polymer, copolymer, or blend thereof. Removable skin layer 120 may have any suitable thickness, including from 10-150 micrometers. The thickness and materials may be selected to impart sufficient stiffness to the film stack and maintain a moderate peel force for delamination. In some embodiments, the 90 degree peel force to delaminate may be between 50 and 100 grams per inch (approximately 20 to 40 grams per centimeter). The removable skin layer may be extruded (melt extrusion or blown film extrusion), solvent cast, or coated.

Removable skin layer 120 has a selected combination of materials and thickness such that when stretched, the skin layer rapidly develops haze. While many materials may develop stretch-induced haze, certain materials will exhibit a rapid increase in haze at a certain elongation threshold. For example, elongation of the skin layer from 0% to 30% may increase the haze by 50 percentage points or more. In some embodiments, elongation of the skin layer from 0% to 30% may increase the haze by 60 percentage points or more. In some embodiments, elongation of the skin layer from 0% to 30% may increase the haze by 70 percentage points or more. In some embodiments, elongation of the skin layer from 0% to 30% may increase the haze by 80 percentage points or more. In some embodiments, elongation of the skin layer from 0% to 30% may increase the haze by 90 percentage points or more.

Liner 130 may be provided as part of film stack 100 to protect pressure sensitive adhesive 140 from exposure to elements, degradation, and unintentional adhesion. Liner 130 also permits film stack 100 to be configured, stored, and transported as a roll, without self-adhesion. Liner 130 may be any suitable material, commonly including paper or a polymer such as polyethylene. In some embodiments, liner 130 is coated or covered with optional release layer 132 which may enhance the smoothness and/or ease of separation between the liner and the pressure sensitive adhesive. Optional release layer 132 may be silicone, a wax, a block copolymer, or any other suitable material. In some embodiments, optional release layer 132 may be omitted or not necessary to provide the desired release characteristics.

Pressure sensitive adhesive 140 is disposed between liner 130 and base overlaminate film layer 120. Pressure sensitive adhesive 140 may be any suitable adhesive, including acrylic adhesives, epoxies, or optically clear adhesives. Particularly for transparent or translucent base overlaminate films, the optical characteristics of the adhesive (typically high transmission, low haze, and high clarity) may be important to maintaining the overall appearance of the film in use. The pressure sensitive adhesive may be extruded (melt extrusion or blown film extrusion), solvent cast, or coated.

In some embodiments, pressure sensitive adhesive 140 may have sufficient structure to maintain its shape (i.e., to not flow) over a range of exposure temperatures and humidities. In some embodiments, the adhesive may be fully or partially crosslinked. The adhesive may include a pigment, dye, or other colorant. In some embodiments, the thickness of the adhesive may be between 10 and 100 micrometers. In some embodiments, the adhesive may include partially embedded microbeads, made from materials such as glass, ceramic, or polymeric resin or agglomerations thereof held together with a suitable binder material. In some embodiments, the microbeads may be index matched to the structured adhesive and/or be transparent.

Because the base overlaminate film layer may not inherently bond well to the pressure sensitive adhesive, some embodiments may include optional tie layer 150. The tie layer, also often called a primer or prime layer, may be any suitable substance or composition with any suitable thickness. The selection of the tie layer is to ensure sufficient adhesion (to prevent ply-bold failure) between the base overlaminate film layer and the pressure sensitive adhesive. In some embodiments, the tie layer may include a polyamide or copolyamide. Certain materials may be alternatively or additionally useful as a barrier layer to prevent the migration of plasticizer, water, solvent, or other contaminants from the front side of the film stack into the adhesive. The tie layer may be extremely thin: less than 10 micrometers thick, less than 6 micrometers thick, less than 5 micrometers thick, less than 4 micrometers thick, less than 3 micrometers thick, less than 2 micrometers thick, or even less than 1 micrometer thick. Tie layers can be solvent cast, coated, or even extruded or coextruded (with one or more of the other layers).

Film stack 100, overall, is stretchable together to some degree without causing irreversible damage to the base overlaminate layer. In some embodiments, film stack 100 is stretchable to 30% elongation without causing irreversible damage to the base overlaminate layer. In some embodiments, film stack 100 is stretchable to 50% elongation without causing irreversible damage to the base overlaminate layer. In some embodiments, film stack 100 is stretchable to 100% elongation, 200% elongation, or more without causing irreversible damage to the base overlaminate layer. Being stretchable helps apply such films to complex, curved, or channeled surfaces with minimal lifting. However, every stretchable film has a limit where it will undergo irreversible plastic deformation and eventually break or tear. In some cases, the stress of an overstretched film will cause it to lift off of a surface it is adhered to. In some cases, the film may develop optical artifacts such as haziness.

It is important to avoid overstretching during use and installation. In embodiments described herein, the removable skin layer develops haze when the film stack is stretched, at or before the point where the base overlaminate layer becomes irreversibly optically or physically damaged. In some embodiments, the removable skin layer develops haze at or before the point where any of the layers undergo irreversible damage.

Accordingly, constructions and stacks described herein may be useful as they provide a visual indication to an installer or user that the base overlaminate film is approaching the physical limit of its recommended elongation. Because the removable skin layer can be stripped after application, the user can stop stretching at or near the point where haze in observed, continue to install the film after being warned about approaching the point of irreversible damage, and remove the skin layer with confidence that the underlying base overlaminate film layer has preserved its optical and physical qualities.

In some embodiments, the film stack described herein is laminated to a base graphics film (i.e., a colored or digitally printed decorative film) and the entire stack may still be stretched together. Like as described elsewhere, the overall film stack may have a recommended or safe limit of elongation. In some embodiments, this may be 30%. In some embodiments, this may be 150%. In some embodiments, this may be 100%, 200%, or more. Similarly, the removable skin layer develops haze at or before the point where the base overlaminate layer and/or the base graphics film are overstretched to the point of failure.

FIG. 2 is a schematic side elevation cross section of another film stack including two base overlaminate film layers and two removable skin layers. Film stack 200 is similar to film stack 100 in FIG. 1; however, FIG. 2 shows an alternative construction where two overlaminate base layers are formed and stored on a single liner layer. Film stack 200 includes two removable skin layers 220, two base overlaminate film layers 210, two optional tie layers 250, two pressure sensitive adhesive layers 240, and a single liner 230, which may or may not include a release coating on one or both surfaces.

Each component in FIG. 2 is as described in conjunction with FIG. 1, except that the manufacture of the particular film stack may be advantageously suited to extrusion processes. The formation of two usable film sides with a single liner can provide a more economical manufacture, storage, and shipping, with less waste. Additionally, when film stack 200 is stored or configured as a roll, removable skin layers 220 act as a protective liner to minimize surface impressions or scratches on the base overlaminate film.

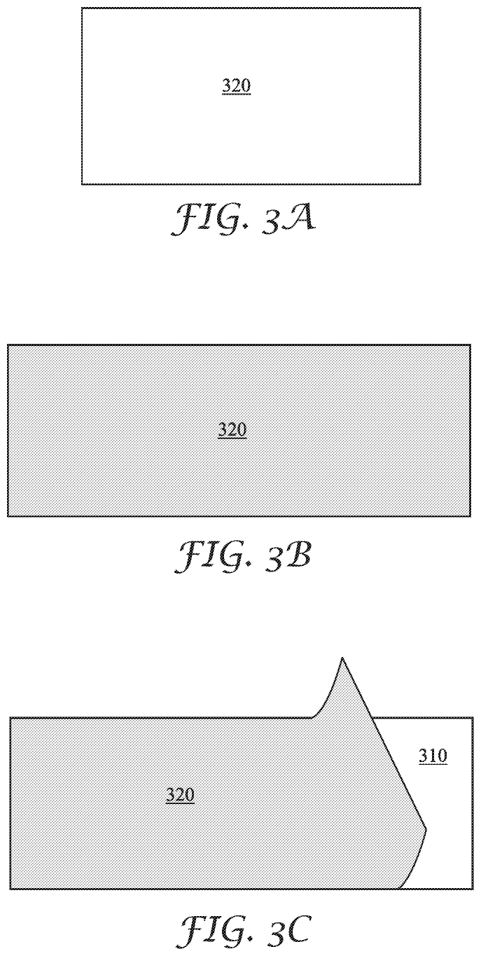

FIG. 3A-3C are schematic top plan views of an unstretched film stack (such as the film stack described and shown in conjunction with FIG. 1), a film stack stretched so that the removable skin layer develops haze, and a film stack with the hazy removable skin layer delaminated from the film stack, revealing the base overlaminate film layer underneath.

In the first step, FIG. 3A shows a top view of a film stack with removable skin layer 320 visible. In some embodiments, removable skin layer 320 is substantially transparent or clear and the surface of the underlying base overlaminate film is visible through the top surface.

In the second step, FIG. 3B shows a top view of a film stack with both removable skin layer 320 and any underlying layers (such as base overlaminate film 310) stretched. In some embodiments, this may be 130% or even 150% elongation. The removable skin layer has developed haze due to the stretching. In some embodiments, develops haze means that the haze changes more than 50 percentage points from unstretched to stretched. In some embodiments, develops haze means that the haze changes more than 60 percentage points from unstretched to stretched. In some embodiments, develops haze means that the haze changes more than 70 percentage points from unstretched to stretched. In some embodiments, develops haze means that the haze changes more than 80 percentage points from unstretched to stretched. In some embodiments, develops haze means that the haze changes more than 90 percentage points from unstretched to stretched. The underlying base overlaminate film has not developed haze and has remained within its recommended stretching range for physical and optical integrity.

In the third step, FIG. 3C shows a top view of a film stack with the removable skin layer being delaminated from the base overlaminate film layer. Removable skin layer 320 retains its haze but may be easily and cleanly removed to reveal the protected base overlaminate film 310 underneath. The skin layer may be removed before, during, or after final installation on a desired substrate.

### EXAMPLES

Materials

| Material | Provider |
|---|---|
| SURLYN 1705-1 Ionomer | DuPont Company, Wilmington, |
| | Delaware |
| SURLYN 1706 Ionomer | DuPont Company, Wilmington, |
| | Delaware |
| SURLYN 1707 Ionomer | DuPont Company, Wilmington, |
| | Delaware |
| ELITE 5960G Enhanced | The Dow Chemical Company, |
| Polyethylene Resin (HDPE) | Midland, MI |
| UNIVAL DMDH-6400 NT7 High | The Dow Chemical Company, |
| Density Polyethylene Resin (HDPE) | Midland, MI |
| LDPE 611A | The Dow Chemical Company, |
| | Midland, MI |
| Petrothene NA217000 a | LyondellBasell, Rotterdam, |
| low density polyethylene | Netherlands |
| ADSTIF HA802H Polypropylene | LyondellBasell, Rotterdam, |
| | Netherlands |
| PP H110-02N | The Dow Chemical Company, |
| | Midland, MI |
| PEBAX 3533 SA 01 | Arkema S.A., Colombes, France |
| NUCREL 31001 Acid Copolymer | DuPont Company, Wilmington, |
| | Delaware |
| 3M Optically Clear Adhesive 8171 | 3M Company, St. Paul, MN |
| INFUSE 9507 | The Dow Chemical Company, |
| | Midland, MI |

### Preparation of Examples

Examples 1 through 3 and Comparative Examples 1 through 5 were made on a 3 layer blown film line. This line has a customer-setup 3 layer die with 2 inch opening, connected to 3 independent ¾″ Brabender single screw extruders (Brabender GmbH & Co. KG, KulturstraBe 49-55 47051 Duisburg). Examples 4, 5 and 6, and Comparative Example 6 were produced on seven-layer pancake stack die (Type LF-400 Coex 7-layer from Labtech Engineering). Airflow to the die was manually controlled to achieve a blow-up ratio of approximately 2:1. The bubble was subsequently collapsed approximately ten feet above die, traversed through rollers then wound onto a 3-inch core and rolled up. The feed materials were supplied by 7 independent 20 mm diameter extruders (Labtech Scientific Single Screw Extruder Type LE20-30/C HA).

The composition of the Examples and Comparative Examples are listed in the table below.

### 3 Layer Blown Films

| (about 1 mil, or | Extruder 1 | | |
|---|---|---|---|
| 25 micrometers, | (Inner layer | Extruder 2 | Extruder3 |
| for each layer) | skin layer) | (Middle layer) | (outer layer) |
| Comparative | LDPE | Surlyn 1706 | Surlyn 1706 |
| Example 1 | (NA217000) | | |
| Comparative | LDPE Dow | Surlyn 1706 | Surlyn 1706 |
| Example 2 | 611A | | |
| Comparative | HDPE Elite | Surlyn 1706 | Surlyn 1706 |
| Example 3 | 5960G | | |
| Comparative | HDPE | Surlyn 1706 | Surlyn 1706 |
| Example 4 | DMDH6400 | | |
| Example 1 | polypropylene | Surlyn 1706 | Surlyn 1706 |
| | Dow H110-02N | | |
| Example 2 | polypropylene | Surlyn 1707 | Surlyn 1707 |
| | Dow H110-02N | | |
| Example 3 | polypropylene | Surlyn 1705 | Surlyn 1705 |
| | Dow H110-02N | | |
| Comparative | PEBAX | Surlyn 1705 | Surlyn 1705 |
| Example 5 | | | |

### 7 Layer Blown Films

| | Extruder 1 | | Extruder 7 |
|---|---|---|---|
| | (inner layer) skin | Extruder 2-6 | (outer layer) |
| Example 4 | 0.3 mil PP | 1.7 mil | 0.3 mil |
| | (Adstif HA802H) | Surlyn 1706 | PEBAX 3533 |
| Example 5 | 0.5 mil PP | 1.7 mil | 0.3 mil |
| | (Adstif HA802H) | Surlyn 1706 | PEBAX 3533 |
| Comparative | 0.3 mil | 1.4 mil | 0.3 mil |
| Example 6 | Surlyn 1706 | Surlyn 1706 | PEBAX 3533 |

### Test Methods

### 90° Peel Force Measurement

90-degree peel test was conducted on Peel Tester (80-91 LAB MASTER Release & Adhesion Tester) made by Testing Machines, Inc. (New Castle, Del. 19720 USA). The samples were conditioned in CTH (constant temperature 73 F and humidity 50%) room for at least 24 hours. Conditioned samples were cut into 2.5 cm (TD, Transverse Direction) and approximately 30.5 cm (machine direction) strips. The samples were laminated to a metal plate using 3M Optically Clear Adhesive 8171 with the ionomer film side facing the adhesive and the peel force for peeling the strippable skin was measured. The 90 degree peel force (in grams) was measured at a speed of 120 inch/min.

### Table 3 90° Peel Force

| Sample | Peel force, grams |
|---|---|
| Example 4 | 86 |
| Example 5 | 92 |

### Optical Haze Measurement

The optical haze of samples was measured with a Haze-Gard Plus hazemeter, which is commercially available from BYK Instruments (Columbia, Md. 21046-2729, USA). The samples were cut into 38 mm×127 mm (1.5″×5.0″). The optical haze was measured for unstretched samples and samples stretched to 30%. These samples were laminated to a clear 3 mm thick 60 mm×240 mm general purpose acrylic panel using 3M Optically Clear Adhesive 8171 before the measurement. The skin side was on the air side. The results are listed on Haze results table below.

### Haze Results

| | Haze of non- | Haze for 30% | Haze level |
|---|---|---|---|
| | stretched | Stretched | increase |
| Comparative 1 | 9.41 | 8.93 | −0.48 |
| Comparative 2 | 5.95 | 7.82 | 1.87 |
| Comparative 3 | 19.3 | 15.6 | −3.7 |
| Comparative 4 | 21.3 | 21.8 | 0.5 |
| Example 1 | 3.52 | 90.8 | 87.28 |
| Example 2 | 3.33 | 98.4 | 95.07 |
| Example 3 | 2.48 | 98.8 | 96.32 |
| Comparative 5 | 6.33 | 5.3 | −1.03 |
| Example 4 | 31.5 | 93 | 61.5 |
| Example 5 | 30.1 | 98.3 | 68.2 |
| Comparative 6 | 3.84 | 3.64 | −0.2 |

### Film Tensile Property

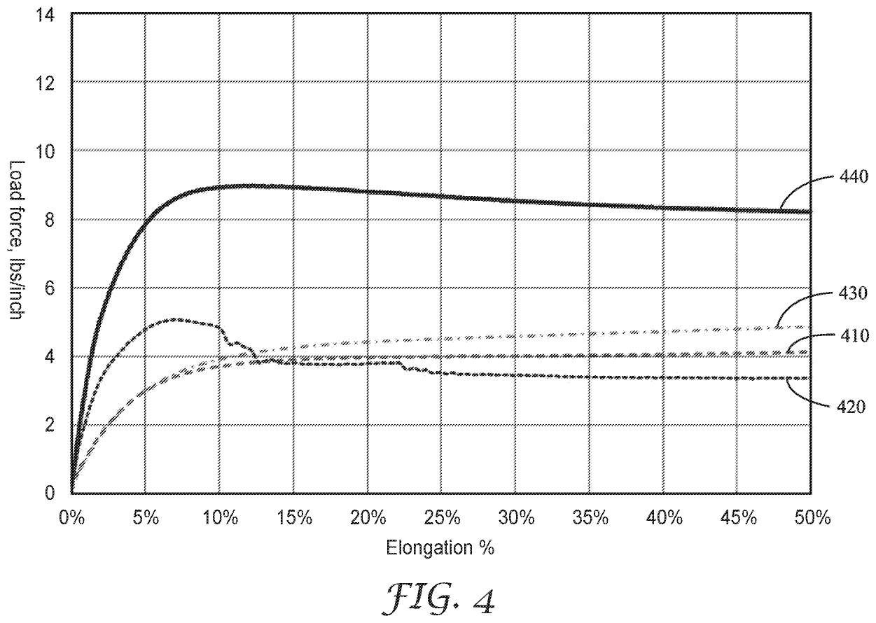

The samples were cut into 38 mm×127 mm (1.0″×5.0″) on machine direction after the films were conditioned for 24 hours in CTH (constant temperature and humidity, 23 C and 50%) room. The tests were performed using a tensile machine by Instron (Model: EMSYSU 4242, Norwood, Mass. 02062) at a crosshead speed of 12″/min (304.8 mm/minute) with 2 inch (50.8 mm) gap. Each of the Examples were able to be stretched up to 150%. FIG. 4 shows the load force (lbs/inch) for selected Examples and components of

Examples versus elongation (%). At the range of elongation for handling and lamination (low levels), the rigidity of the skin layer 420 is greater than the overlaminate base layer 410. Likewise, the full construction of Example 3 440 (including the rigid skin layer) is more rigid than Comparative Example 5 430.

What is claimed is:

1. A film stack, comprising:
a base overlaminate film layer formed from a first material and having first and second major surfaces;
a removable skin layer formed from a second material disposed on the first major surface of the base overlaminate film; and
an adhesive layer disposed on the second major surface of the base overlaminate film;
wherein the base overlaminate film layer is transparent;
wherein removable skin layer is more rigid than the base overlaminate film layer;
wherein the film stack is stretchable to 30% elongation without causing irreversible damage to the base overlaminate layer.

2. The film stack of claim 1, wherein, when the film stack is stretched together, the removable skin layer develops haze while the base overlaminate film layer remains transparent.

3. The film stack of claim 1, wherein the removeable skin layer has a thickness between 10 and 150 micrometers.

4. The film stack of claim 1, wherein the film stack includes a tie layer between the adhesive layer and the base overlaminate film layer.

5. A roll of film including the film stack of claim 1, wherein the film stack is disposed on a liner.

6. The film stack of claim 1, wherein the first material and the second material are extrudable.

7. The film stack of claim 1, wherein the first material includes polyvinyl chloride.

8. The film stack of claim 1, wherein the first material includes polyurethane.

9. The film stack of claim 1, wherein the second material includes polypropylene.

10. The film stack of claim 1, wherein the base overlaminate layer includes an ionomer.

11. A film stack, comprising:
a base overlaminate film layer; and
a removable skin layer disposed on a major surface of the base overlaminate film;
wherein, when the film stack is stretched, the removable skin layer provides a visible indication before causing irreversible damage to the base overlaminate film.

12. The film stack of claim 11, wherein the visible indication is a sudden increase in haze.

13. The film stack of claim 12, wherein the sudden increase in haze is an increase of at least 50 percentage points.

14. A method of preventing overstretching while stretching a film stack, comprising:
providing a film stack including a base overlaminate film layer and a removable skin layer disposed on the base overlaminate film layer, wherein the removable skin layer, when the film stack is stretched, becomes hazy before causing irreversible damage to the base overlaminate film layer;
stretching the film stack less than or up to the point when the removable skin layer becomes hazy.

15. The method of claim 14, wherein stretching the film stack means stretching to 30% elongation.

16. The method of claim 11, wherein stretching the film stack means stretching to 50% elongation.

17. The method of claim 11, wherein stretching the film stack includes stretching it to the point when the removable skin layer increases its haze by 50 percentage points.

18. The method of claim 14, further comprising the step of removing the skin layer.

19. The method of claim 14, comprising the step of further stretching the film.

20. The method of claim 19, comprising the step of applying heat to the film.
